(19) United States
(12) Patent Application Publication
(10) Pub. No.: US 2017/0060245 A1
(43) Pub. Date: Mar. 2, 2017

(54) INPUT DEVICE, INTEGRATED INPUT SYSTEM, INPUT DEVICE CONTROL METHOD, AND PROGRAM

(71) Applicant: FUJITSU TEN LIMITED, Kobe-shi (JP)

(72) Inventors: Osamu KUKIMOTO, Kobe-shi (JP); Masahiro IINO, Kobe-shi (JP); Yutaka MATSUNAMI, Kobe-shi (JP); Hitoshi TSUDA, Kobe-shi (JP); Teru SAWADA, Kobe-shi (JP); Minoru MAEHATA, Kobe-shi (JP)

(73) Assignee: FUJITSU TEN LIMITED, Kobe-shi (JP)

(21) Appl. No.: 15/240,238

(22) Filed: Aug. 18, 2016

(30) Foreign Application Priority Data
Aug. 31, 2015 (JP) 2015-171160
Aug. 31, 2015 (JP) 2015-171161

(51) Int. Cl. G06F 3/01; G06F 3/0484; G06F 3/03; G06F 3/0488; G06F 3/16

(52) U.S. Cl. CPC G06F 3/016; G06F 3/04883; G06F 3/167; G06F 3/013; G06F 3/0304; G06F 3/04842

(57) ABSTRACT

An input device according to an embodiment includes an operation panel, a selection unit, a detector, a vibration element, a setting unit, and a vibration control unit. The selection unit selects a to-be-controlled object using the operation panel in accordance with the user's action. The detector detects touch operation on the operation panel. The vibration element vibrates the operation panel. The setting unit sets a vibration pattern of the vibration element appropriate to the touch operation detected by the detector, depending on the to-be-controlled object selected by the selection unit. The vibration control unit controls the vibration element to generate the vibration pattern set by the setting unit.

### CROSS-REFERENCE TO RELATED APPLICATIONS

This application is based upon and claims the benefit of priority of the prior Japanese Patent Application No. 2015-171160, filed on Aug. 31, 2015 and Japanese Patent Application No. 2015-171161, filed on Aug. 31, 2015, the entire contents of which are incorporated herein by reference.

### FIELD

The embodiment discussed herein is directed to an input device, integrated input system, input device control method, and program.

### BACKGROUND

Input devices, each of which notifies the user that the input device receives input by giving the user a tactile sensation, have been known. Such an input device notifies the user that the input device receives input, for example, by generating vibration in response to the pressure by the user (see, for example, Japanese Laid-open Patent Publication No. 2013-235614).

However, the conventional input device merely generates vibration in response to the pressure on a touch position by the user. For example, how to give the user a tactile sensation as feedback when the user performs the operation for moving a touch position on the operation panel is not considered. As described above, there is room for improvement on the conventional input device in order to increase the usability for the user.

There is, for example, an in-vehicle system in which the various devices are installed and the user needs to control, for example, the devices and the modes of the devices. There is a need for the user to operate such various devices with a high degree of usability.

### SUMMARY

An input device according to an embodiment includes an operation panel, a selection unit, a detector, a vibration element, a setting unit, and a vibration control unit. The selection unit selects a to-be-controlled object using the operation panel in accordance with the user's action. The detector detects touch operation on the operation panel. The vibration element vibrates the operation panel. The setting unit sets a vibration pattern of the vibration element appropriate to the touch operation detected by the detector, depending on the to-be-controlled object selected by the selection unit. The vibration control unit controls the vibration element to generate the vibration pattern set by the setting unit.

### BRIEF DESCRIPTION OF DRAWINGS

A more complete appreciation of the invention and many of the attendant advantages thereof will be readily obtained as the same becomes better understood by reference to the following detailed description when considered in connection with the accompanying drawings, wherein:

FIGS. 1A to 1D are diagrams 1 to 4 of the outline of an input device control method according to an embodiment;

FIG. 2 is a block diagram of an integrated input system according to an embodiment;

FIGS. 3A to 3D are diagrams 1 to 4 of specific examples of the tactile sensations to be given as feedback;

FIGS. 4A to 4C are diagrams 1 to 3 of specific examples of gestures;

FIG. 5A is a diagram of a specific example of combination information;

FIG. 5B is a diagram of a specific example of vibration condition information;

FIG. 6 is a flowchart of a process that an input device according to an embodiment performs;

FIG. 7 is a diagram of an exemplary hardware configuration of a computer that implements a function of an integrated input system according to an embodiment;

FIG. 8 is a timing diagram of an exemplary input device control method according to an exemplary variation;

FIG. 9 is a diagram of an exemplary displayed image;

FIG. 10 is a flowchart of a first excluding process that an input device according to an exemplary variation performs; and

FIG. 11 is a flowchart of a second excluding process that an input device according to an exemplary variation performs.

### DESCRIPTION OF EMBODIMENTS

The embodiments of the input device, integrated input system, input device control method, and program disclosed in the present application will be described in detail hereinafter with reference to the appended drawings. Note that the present invention is not limited to the embodiment to be described below. Note that an example in which an integrated input system 1 is an in-vehicle system will be described in the present embodiment.

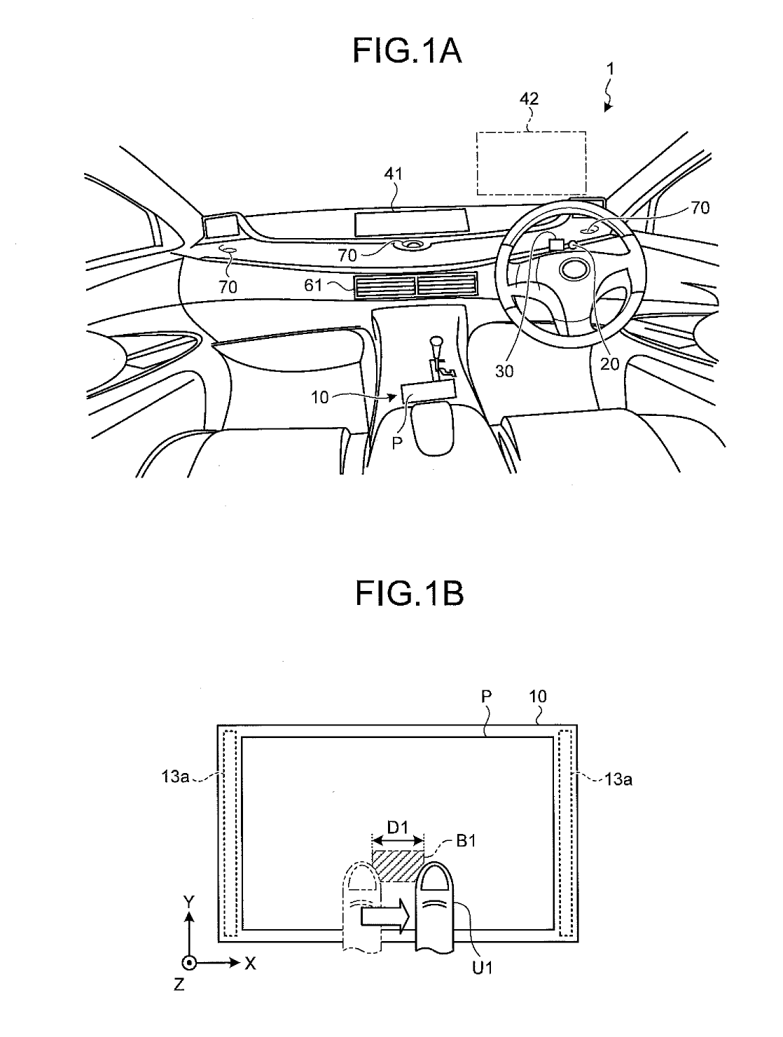

The outline of an input device control method for controlling an input device 10 according to the present embodiment will be described with reference to FIGS. 1A to 1D. FIGS. 1A to 1D are diagrams 1 to 4 of the outline of the input device control method for controlling the input device 10 according to an embodiment.

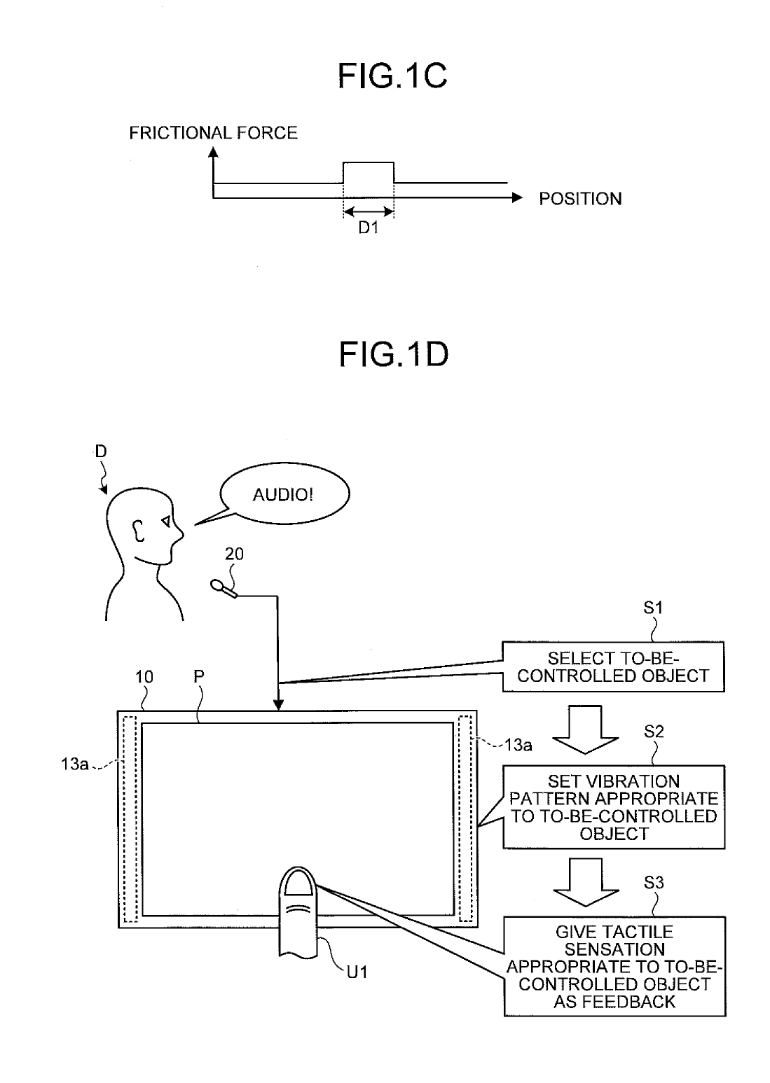

As illustrated in FIG. 1A, the integrated input system 1 includes the input device 10. The input device 10 includes an operation panel P. The operation panel P includes, for example, a touch pad including a capacitance information-input function, and receives from the user D the touch operation for controlling one of various devices 60 that the user D is to control (to be described below with reference to FIG. 2).

The input device 10 is placed at a position at which the user D can reach the operation panel P while driving, for example, near the stick shift of the driver's seat.

More specifically, as illustrated in FIG. 1B, the input device 10 includes at least a vibration element 13a that vibrates the operation panel P. Mote that FIG. 1B illustrates an example in which the input device 10 includes two vibration elements 13a.

The vibration element 13a is, for example, a piezoelectric element so that vibration element 13a can vibrate the operation panel P with ultrasonic wave frequency bands. For example, vibrating the vibration element 13a while a finger U1 of a user D press down the operation panel P can vary the frictional force between the finger U1 and the operation panel P.

Moving the finger U1 in such a state can give the tactile sensation appropriate to the varied frictional force as feedback to the finger U1. Alternatively, changing the vibration pattern of the vibration element 13a can vary the intensity of frictional force between the finger U1 and the operation panel P, and thus can vary the tactile sensation given as feedback to the finger U1.

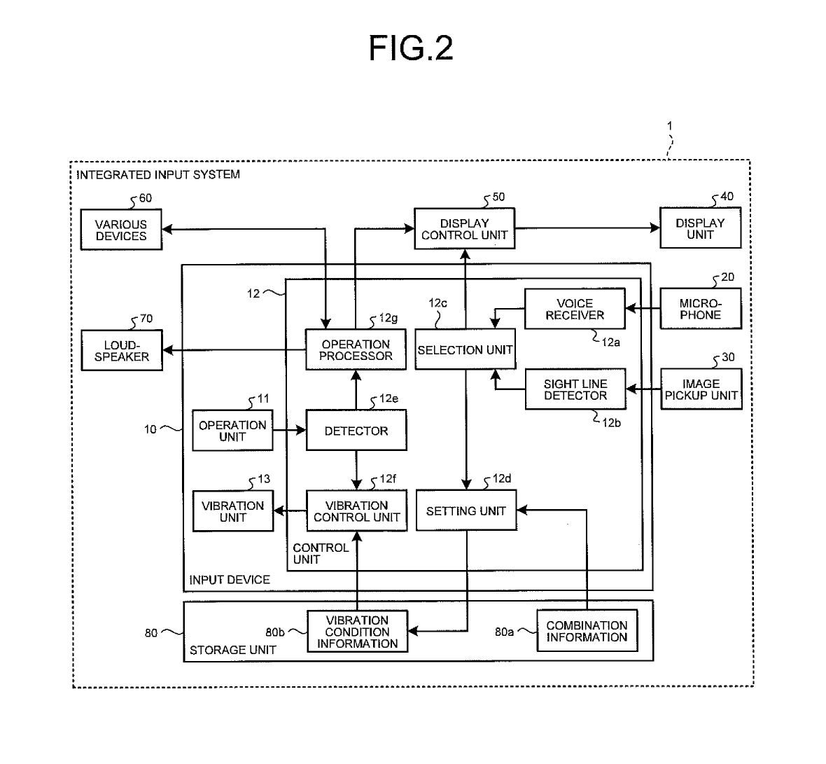

For example, the frictional force in a segment D1 is increased so that the frictional force in the segment D1 is larger than the frictional force in other segments. This increase can give the user D a tactile sensation as if a button B1 is placed on the operation panel P as feedback when the finger U1 is slide right or left in an X axis direction, as illustrated in FIGS. 1B and 1C. Note that the aspect of the tactile sensation described above is only an example. Other specific examples will be described with reference to FIGS. 3A to 3D.

As illustrated in FIG. 1A, the integrated input system 1 further includes a microphone 20 and an image pickup unit 30. The microphone 20 and the image pickup unit 30 are placed, for example, on the upper part of the steering column. The microphone 20 collects and inputs the voice of the user D. The image pickup unit 30 takes an image, for example, of the face of the user D sitting on the driver's seat.

The Integrated input system 1 further includes, for example, a central display 41 and a head-up display (HUD) 42 as a display unit 40 (to be described below with reference to FIG. 2).

The central display 41 is used, for example, as a display unit of an AV navigation device installed as one of the various devices 60, and outputs various types of information in each selected mode such as a navigation mode or an audio mode. The HUD 42 outputs various types of information about driving situation such as the vehicle speed, or the number of revolutions of the engine in the field of sight of the user D who is driving.

The integrated input system 1 further includes an air conditioner 61 as another one of the various devices 60. The integrated input system 1 further includes a loudspeaker 70.

When the various devices 60 are installed on a system as described above, the various devices 60 or modes of the devices are the objects that the user D is to control. The user D often needs to operate the various devices 60 and modes in various manners. Thus, there is a need to operate such various to-be-controlled objects with a high degree of usability in order to improve the convenience for the user D or to ensure the safety.

In light of the foregoing, the integrated input system 1 according to the present embodiment enables the user to collectively operate the various devices 60 or the modes of the devices by the touch operation basically only on one operation panel P. In the operation, tactile sensations varying depending on the various devices 60 or mode of the device that the user D wants to control are given as feedback on the operation panel P.

Note that, to select another device or mode as the to-be-controlled object, a combination of the touch operation on the operation panel P and a method other than the touch operation, for example, voice input operation can be used.

This combination enables the user D to control the object only by touch typing operation without visually recognizing the device. Specifically, as illustrated in FIG. 1D, for example, the user D says the to-be-controlled object among the various devices 60 or the modes of the devices. In the example of FIG. 1D, the user D says “Audio!”.

In this example of the present embodiment, the input device 10 inputs and receives the contents of the user D's speech through the microphone 20, and selects the audio mode of the car navigation as the to-be-controlled object on the operation panel P (see step S1 in the drawing).

Then, the input device 10 sets a vibration pattern of the vibration element 13a appropriate to the audio mode selected as the to-be-controlled object (see step S2 in the drawing). Accordingly, the vibration pattern of the vibration element 13a, which is specific to the audio mode and given when the user D performs the touch operation on the operation panel P with the finger U1 in the audio mode, is set in the input device 10.

When the input device 10 detects touch operation on the operation panel P by the user D while the vibration pattern is set, the input device 10 controls the vibration element 13a to generate the vibration pattern set in step S2 so as to give the user the tactile sensation appropriate to the audio mode that is the to-be-controlled object as feedback (see step S3 in the drawing).

Such control allows for the operation of various to-be-controlled objects using one operation panel P. Note that the touch operation includes several easy gestures, and different vibration patterns are combined with the gestures, respectively, depending on the to-be-controlled objects.

In other words, in the present embodiment, a set of easy gestures is commonly shared among different to-be-controlled objects. The user can operate different to-be-controlled objects, using the set of easy gestures. On the other hand, different tactile sensations are given as feedback in response to the same gestures, respectively, depending on the different to-be-controlled objects.

This enables the user D to operate various to-be-controlled objects by similar types of touch typing operation by only memorizing several easy gestures. In other words, the user can operate various to-be-controlled objects with a high degree of usability.

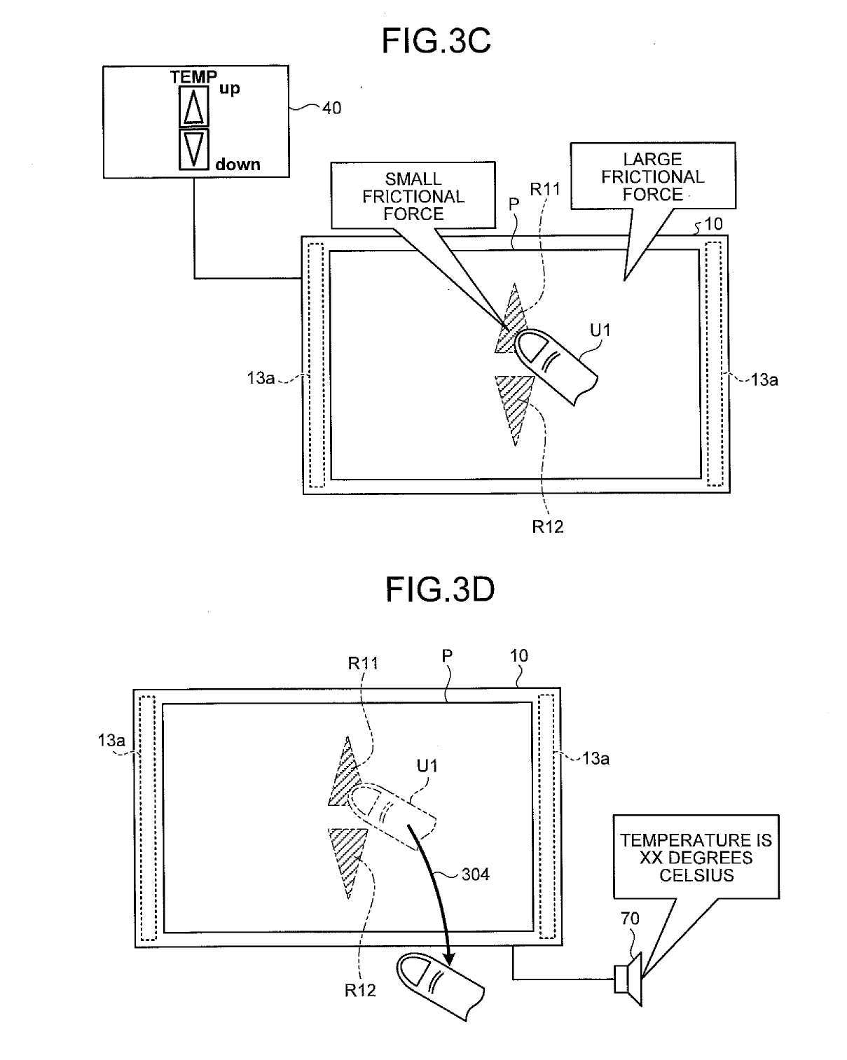

Note that specific examples of the gestures combined with each to-be-controlled object will be describe below with reference to FIGS. 5A and 5B. The method for selecting a to-be-controlled object can be any method as long as the method is based on the action of the user D. The method is not limited to the voice input described above. This point will additionally be described with reference to FIG. 2.

As described above, in the present embodiment, a to-be-controlled object is selected in accordance with the action of the user D. Then, a vibration pattern appropriate to the selected to-be-controlled object is set. When the touch operation on the operation panel P by the user D is detected, the vibration element 13a is controlled to generate the set vibration pattern so that the tactile sensation appropriate to the to-be-controlled object is given as feedback to the user. According to the present embodiment, various to-be-controlled objects can be operated with a high degree of usability.

Note that an example in which the operation panel P of the input device 10 is a touch pad has been descried herein. However, the operation panel P is not limited to the touch pad. The operation panel P can be, for example, a touch panel integrated with the central display 41. Hereinafter, the integrated input system 1 including the input device 10 controlled by the controlling methods described above will be described more specifically.

FIG. 2 is a block diagram of the integrated input system 1 according an embodiment. Note that FIG. 2 illustrates only components necessary to describe the features of the present embodiment in a functional block diagram. The description of general components is omitted.

In other words, each component illustrated in FIG. 2 is functionally conceptual, and does not necessarily have a physical structure as illustrated. For example, a specific form of separation and/or incorporation of the functional blocks are not limited to the illustrated form. All or some of the functional blocks can functionally or physically be divided and/or incorporated in an arbitrary unit in consideration of various loads or usage conditions.

As illustrated in FIG. 2, the integrated input system 1 includes the input device 10, the microphone 20, the image pickup unit 30, the display unit 40, a display control unit 50, the various devices 60, the loudspeaker 70, and a storage unit 80.

The microphone 20 collects the voice of the user D and inputs the voice to the input device 10. The image pickup unit 30 includes, for example, an infrared LED and an infrared camera so as to illuminate the user D with the infrared LED and takes an image, for example, of the face of the user D with the infrared camera, and then input the image to the input device 10.

The display unit 40 is, for example, the central display 41 or HUD 42, and provides the user D with an image as the visual information output from the display control unit 50.

The display control unit 50 generates an image to be displayed on the display unit 40 and outputs the image to the display unit 40, for example, in accordance with the contents of the operation that the input device 10 receives from the user D. The display control unit 50 controls the display unit 40 to provide the user D with an image.

The various devices 60 include, for example, the navigation device or the air conditioner 61, and are objects that the user D is to control through the input device 10. The loudspeaker 70 provides the user D with voice as the audio information, for example, in accordance with the contents of the operation that the input device 10 receives from the user D.

The storage unit 80 is a storage device such as a hard disk drive, a non-volatile memory, or a register, and stores a combination information 80a and a vibration condition information 80b.

The input device 10 is an information input device including, for example, a touch pad or a touch panel as described above, and receives the input operation from the user D, and outputs the signal in response to the contents of the operation to the display control unit 50, the various devices 60, and the loudspeaker 70.

The input device 10 includes an operation unit 11, a control unit 12, and a vibration unit 13. First, the operation unit 11 and the vibration unit 13 will be described. The operation unit 11 is, for example, a board-shaped sensor such as a touch pad or a touch panel as described above, and includes the operation panel P that receives the input operation from the user D (see, for example, FIG. 1A). When the user D touches the operation panel P, the operation unit 11 outputs a sensor value in response to the touch operation of the user D to the control unit 12.

The vibration unit 13 includes at least a vibration element 13a (see, for example, FIG. 1B). The vibration element 13a is, for example, a piezoelectric actuator such as a piezoelectric element (piezo element), and vibrates the operation unit 11 by expanding or contracting in response to the voltage signal from the control unit 12. The vibration element 13a is placed at a position difficult for the user D to visually recognize, for example, on an edge of the operation unit 11 while the vibration element 13a has contact with the operation unit 11.

Note that, although the vibration elements 13a are arranged in the regions on right and left outer sides of the operation panel P and on the surface facing the operation panel P in the example illustrated in FIG. 1B, the arrangement is an example, and the arrangement of the vibration elements 13a is not limited to the example.

For example, only a vibration element 13a can vibrate the operation panel P. As described above, the number and arrangement of vibration elements 13a are arbitrary. However, the number and arrangement with which the whole operation panel P can evenly be vibrated are preferable. The vibration element 13a is not necessarily a piezoelectric element, and can be, for example, an element that can vibrate the operation panel P with ultrasonic wave frequency bands.

Next, the control unit 12 will be described. As illustrated in FIG. 2, the control unit 12 includes a voice receiver 12a, a sight line detector 12b, a selection unit 12c, a setting unit 12d, a detector 12e, a vibration control unit 12f, and an operation processor 12g.

The control unit 12 controls each unit of the input device 10. The voice receiver 12a receives the voice input from the microphone 20, and analyzes the contents of the voice, and then gives the analysis result to the selection unit 12c.

The sight line detector 12b detects the direction, of line of sight of the user D, for example, from the positional relationship between the infrared illumination reflected image on the eyeball (corneal reflex) and the pupil in the image of the face taken by the image pickup unit 30, and gives the detection result to the selection unit 12c.

When receiving the analysis result from the voice receiver 12a, the selection unit 12c selects the object that the user D wants to control in accordance with the analysis result. When receiving the detection result from the sight line detector 12b, the selection unit 12c selects the object that the user D wants to control in accordance with the detection result.

In other words, the selection unit 12c can select a to-be-controlled object in accordance with the direction that the user D gazes. The selection unit 13c notifies the setting unit 12d of the selected to-be-controlled object.

When touch operation by the user D is detected, the setting unit 12d sets the vibration pattern of the vibration element 13a appropriate to the detected touch operation depending on the to-be-controlled object selected by the selection unit 12c.

Specifically, when a gesture is made for the to-be-controlled object selected by the selection unit 12c, the setting unit 12d sets the vibration pattern of the vibration element 13a specific to the selected to-be-controlled object in accordance with the combination information 80a in which different vibration patterns of the vibration element 13a are combined with the gestures, respectively, depending on the to-be-controlled objects. An example of the combination information 80a will be described with reference to FIG. 5A.

The setting unit 12d stores the set contents as the vibration condition information 80b in the storage unit 80. For example, the vibration condition information 80b includes a control value used to control the vibration element 13a. An example of the vibration condition information 80b will be described with reference to FIG. 5B.

The detector 12e detects a predetermined gesture made by the user D on the operation panel P in accordance with the sensor value output from the operation unit 11, and gives the detection result to the vibration control unit 12f and the operation processor 12g.

When the detector 12e detects a gesture, the vibration control unit 12f controls the vibration element 13a of the vibration unit 13 with reference to the vibration condition information 80b to generate the vibration pattern set by the setting unit 12d. Specific examples of the tactile sensation that the vibration control unit 12f gives as feedback to the user by controlling the vibration element 13a will be described below with reference to FIGS. 3A to 3D.

The operation processor 12g causes the display control unit 50 to visually give the contents of the operation corresponding to the gesture detected by the detector 12e as feedback to the display unit 40. The operation processor 12g performs a process for reflecting the contents of the operation corresponding to the gesture on the to-be-controlled object among the various devices 60.

The operation processor 12g outputs, for example, a guidance voice in response to the gesture from the loudspeaker 70. In other words, when a tactile sensation is given as feedback to the user D through the operation panel P, the guidance voice from the loudspeaker 70 is also used as described above. This increases the usability, for example, by aurally supporting the touch typing operation of the user D.

Next, specific examples of the tactile sensations given as feedback to the user, varying depending on the to-be-controlled object will be described with reference to FIGS. 3A to 3D. FIGS. 3A to 3D are diagrams 1 to 4 of specific examples of the tactile sensations given as feedback.

First, with reference to FIGS. 3A and 3B, an example in which the to-be-controlled object is a volume UP/DOWN function in the audio mode will be described. Accordingly, the user D completes selecting the function as the to-be-controlled object by saying, for example, “Volume.”.

In this example, as illustrated in FIG. 3A, for example, the vibration pattern of the vibration element 13a, which can give a tactile sensation like a volume adjustment dial as feedback, is set on the operation panel P of the input device 10.

Specifically, in this example, a region R1, for example, that is the trace of a circle drawn on the operation panel P is set. Meanwhile, the region other than the region R1 is set as a region R2. The region R1 is set as the region with a small fractional force whereas the region R2 is set as a region with a relatively large frictional force.

The difference in frictional force is implemented by the control of the vibration patterns of the vibration element 13a by the vibration control unit 12f. In other words, when the finger U1 touches a position in the region R1, the vibration control unit 12f generates, for example, a voltage signal with which the vibration element 13a is vibrated at a high frequency, (for example, ultrasonic wave frequency bands) so as to vibrate the vibration element 13a with the voltage signal.

On the other hand, when the finger U1 touches a position in the region R2, the vibration control unit 12f generates, for example, a voltage signal with which the vibration element 13a is vibrated at a frequency lower than the frequency when the finger touches a position in the region R1 so as to vibrate the vibration element 13a with the voltage signal.

This can give the tactile sensation that makes the finger U1 smoothly move as feedback to the user D in the region R1 (see an arrow 301 in the drawing). On the other hand, in the region R2 outside the region R1, the tactile sensation that does not make the finger U1 smoothly move can be given as feedback to the user D (see an arrow 302 in the drawing).

This enables the user D to input the operation for the volume UP/DOWN function by drawing the trace of a circle similarly to actually adjusting a dial on the operation panel P with the linger U1 while being guided by the smooth tactile sensation along the region R1. Note that, during the operation, for example, an image of a volume adjustment dial can visually be given as feedback on the display unit 40 as illustrated in FIG. 3A.

Such visual feedback is effective, for example, when the sight line detector 12b indicates that the user D continuously gases the central display 41. In other words, it is assumed from the indication that the user D is not driving the vehicle. Thus, the user D can surely operate the to-be-controlled object by using the visual feedback together with the tactile sensation.

On the other hand, for example, when the sight line detector 12b indicates that the user D gazes the HUD 42, it is assumed that the user D is driving the vehicle. It is preferable for safety purposes to limit the visual feedback on the display unit 40 and to only receive, for example, the touch typing operation from the operation panel P.

An exemplary tactile sensation given as feedback to the user to support the touch typing operation as described above is illustrated in FIG. 3B. For example, when the user draws the trace of a circle with the finger U1 (see an arrow 303 in the drawing), the frictional force can be controlled to vary so that a tactile sensation like a click is given to the user at a position corresponding to a tick of the volume adjustment dial.

In this example, for example, a sound “click!” can be output through the loudspeaker 70. Alternatively, the vibration control unit 12f can output a sound by vibrating the vibration element 13a of the vibration unit 13 in a range in which the vibration is audible.

Next, with reference to FIGS. 3C and 3D, an example in which the to-be-controlled object is a function for adjusting the temperature settings of the air conditioner 61 will be described. Accordingly, the user D completes selecting the function as the to-be-controlled object, for example, by saying “the temperature of the air conditioner”.

In this example, as illustrated in FIG. 3C, for example, the vibration pattern of the vibration element 13a, which can give a tactile sensation like UP/DOWN buttons for adjusting the temperature as feedback to the user, is set on the operation panel P of the input device 10.

Specifically, in this example, for example, a region R11 corresponding to the UP button and a region R12 corresponding to the DOWN button are set on the panel P. These regions R11 and R12 are set as regions with a large frictional force whereas the region other than the regions R11 and R12 is set as a region with a relatively small frictional force.

This can give a tactile sensation as if the UP button exists in the region R11 as feedback to the user D. Similarly, a tactile sensation as if the DOWN button exists in the region R12 can be given as feedback to the user D.

As illustrated in FIG. 3D, the user D can turn the temperature settings of the air conditioner 61 up, for example, by pressing down the region R11. For example, a guidance voice saying “the temperature is XX degrees Celsius.” can be output from the loudspeaker 70 at a time when the user B removes the finger U1 from the region R11 (see an arrow 304 in the drawing). Such a guidance voice can support the touch typing operation with certainty and a high degree of usability.

FIGS. 3C and 3D merely illustrate an example of the regions correspond to the UP/DOWN buttons for adjusting the temperature. Note that, however, the regions can be set, for example, as a linear slider bar extending up and down. Then, a small frictional force is set to the region so that sliding the finger U1 up or down in the region can perform the operation.

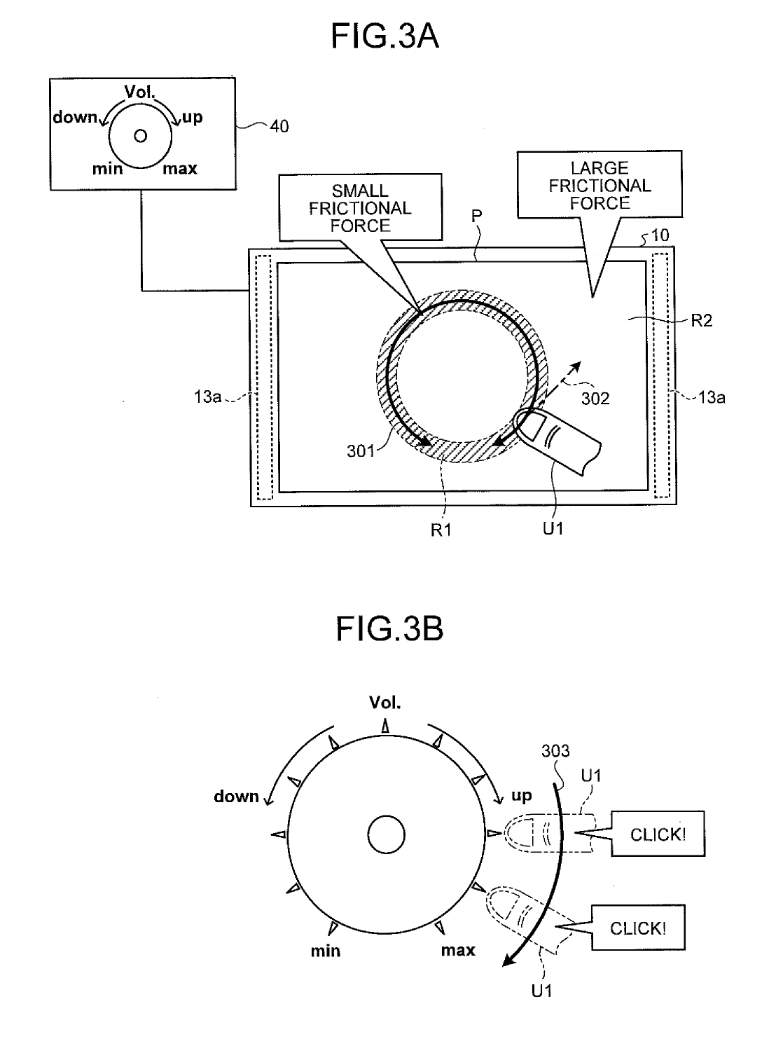

Next, the gestures will be described with reference to FIGS. 4A to 4C. The gestures, for example, in which the user draws the trace of a circle with the finger U1 and in which the user moves the finger U1 up or down have been described above. Thus, other examples will be described hereinafter.

FIGS. 4A to 4C are diagrams 1 to 3 of specific examples of gestures. As described above, the gestures are preferably easy to perform and memorize for the user D in order to increase the usability.

One of the examples is illustrated in FIG. 4A. For example, the finger U1 is slid right or left on the operation panel F as a gesture.

Another example is illustrated in FIG. 4B. For example, the finger U1 is slid to draw the trace of a triangle on the operation panel P as a gesture.

Another example is illustrated in FIG. 4C. For example, the finger U1 is slid to draw the trace of a cross on the operation panel P as a gesture.

In the present embodiment, different vibration patterns are combined with such gestures easy to perform and memorize depending on the to-be-controlled objects.

In other words, in the input device 10 of the present embodiment, the user operates each to-be-controlled object using a set of easy gestures that can be shared among the different to-be-controlled objects. Different tactile sensations are given as feedback in response to the same gestures, respectively, depending on the different to-be-controlled objects.

This enables the user D to operate various to-be-controlled objects by only memorizing several easy gestures, and to receive different tactile sensations from different devices, respectively. Thus, the user can operate various to-be-controlled objects with a high degree of usability.

Specific examples of the combination information 80a and the vibration condition information 80b to achieve the operation with a high degree of usability will be described with reference to FIGS. 5A and 5B. FIG. 5A is a diagram of a specific example of the combination information 80a. FIG. 5B is a diagram of a specific example of the vibration condition information 80b.

First, as described above, the combination information 80a defines that different vibration patterns of the vibration element 13a are combined with the gestures made for the different to-be-controlled objects.

Specifically, as illustrated in FIG. 5A, the combination information 80a includes, for example, items of the to-be-controlled objects, the gestures, the functions, and the vibration patterns. The to-be-controlled object item is divided, for example, into the device item and the mode item of the devices.

For example, the navigation device includes a plurality of modes including the navigation mode and the audio mode as the to-be-controlled objects. A common set of gestures is allotted to the modes. For example, the set in this example includes the five gestures “up or down”, “right or left”, “circle”, “triangle”, and “cross” described above.

In the navigation mode of the navigation device, for example, a function for scrolling a map (up or down) is allotted to the gesture “up or down”, and a first vibration pattern specific to the function is linked to the function in the vibration pattern item.

On the other hand, in the audio mode of the navigation device, a function for switching tracks is allotted to the same gesture “up or down”, and a sixth vibration pattern specific to the function is linked to the function in the vibration pattern item.

Similarly, in the navigation mode and the audio mode, individual functions are allotted to the same gestures “right or left”, “circle”, “triangle”, and “cross”, respectively, and second to fifth and seventh to tenth vibration patterns specific to the individual functions are linked to the functions, respectively, in the vibration pattern item.

For the air conditioner 61, for example, a function for fuming the temperature settings UP/DOWN is allotted to the gesture “up or down”. Fox example, an eleventh vibration pattern specific to the function is linked to the function.

By the way, the selection of the to-be-controlled object from the various devices 60 and modes of the devices is sometimes disabled due to disconnection or failure. In light of the foregoing, the combination information 80a can include, for example, a twelfth vibration pattern “commonly” applied to all the to-be-controlled objects in order not to vibrate the vibration element 13a.

For example, when the detector 12e detects a gesture, the setting unit 12d sets the vibration pattern of the vibration element 13a appropriate to the detected gesture depending on the to-be-controlled object selected by the selection unit 12c with reference to the combination information 80a defined as illustrated in FIG. 5A. The setting unit 12d performs such setting, for example, by writing the information indicating which vibration pattern is selected onto the vibration condition information 80b.

The vibration condition information 80b includes a control value used to control the vibration element 13a for each vibration pattern. Specifically, as illustrated in FIG. 5B, the vibration condition information 80b includes, for example, a current setting item, a vibration pattern item, a touch position coordinates item, and a vibration frequency item.

The vibration pattern item is the information used to identify each vibration pattern. The coordinates of a touch position of the finger U1 on the operation panel P are defined for each vibration pattern. For example, a vibration frequency with which the vibration element 13a vibrates is linked to the coordinates of each position.

The setting unit 12d writes the information indicating the selected vibration pattern in the current setting item. For example, FIG. 5B illustrates an example in which a check mark is put on the first vibration pattern. This means that the setting unit 12d puts the check mark in order to indicate that the first vibration pattern is currently set.

Note that FIG. 5B illustrates the example of the twelfth vibration pattern described as the pattern used not to vibrate the vibration element 13a in FIG. 5A. For example, control values including the coordinates of a position and a vibration frequency are not defined for the twelfth vibration pattern.

The vibration control unit 12f controls the vibration element 13a by using the control values including the coordinate of the position and the vibration frequency linked to the currently set vibration pattern with reference to the vibration condition information 80b described above.

Note that the combination information 80a and the vibration condition information 80b illustrated in FIGS. 5A and 5B are merely examples. The information is not limited to the examples.

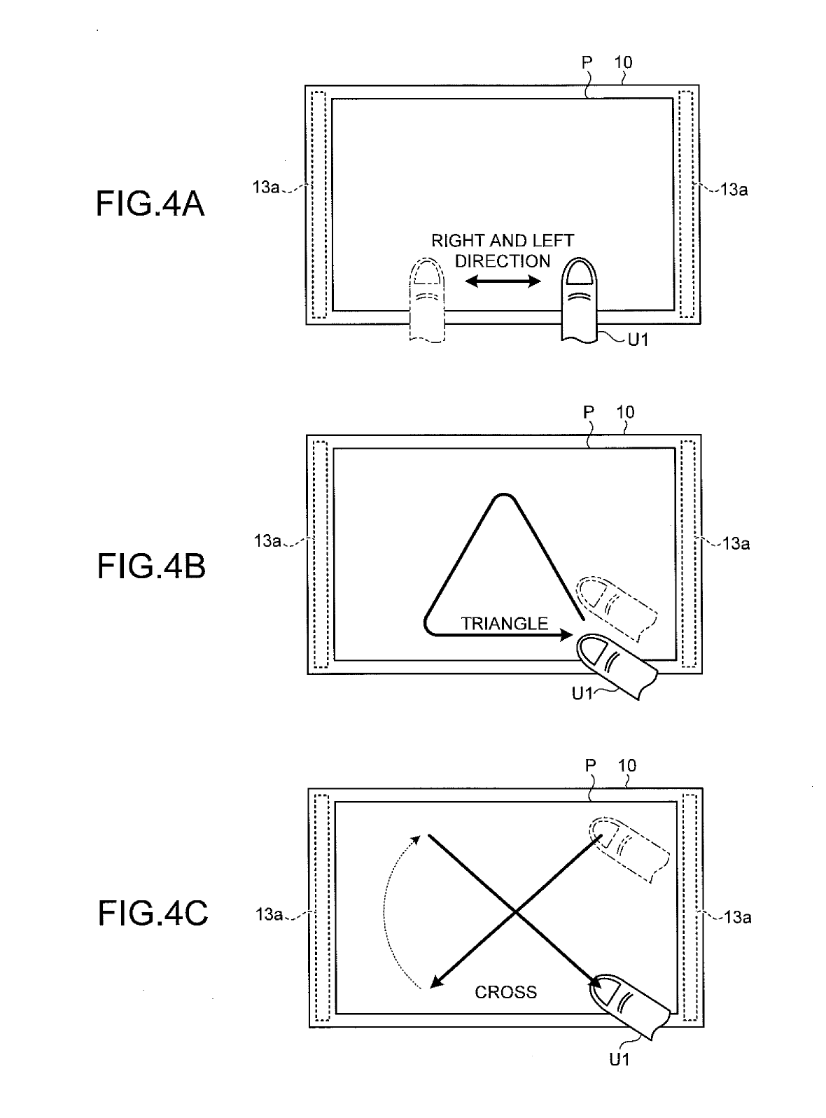

Next, a process that the input device 10 according to an embodiment performs will be described with reference to FIG. 6. FIG. 6 is a flowchart of a process that the input device 10 according to an embodiment performs.

As illustrated in FIG. 6, the selection unit 12c of the input device 10 selects a to-be-controlled object in accordance with the user D's action (step S101). Subsequently, the setting unit 12d sets a vibration pattern of the vibration element 13a appropriate to the to-be-controlled object selected by the selection unit 12c (step S102).

Subsequently, the detector 12e detects the touch operation on the operation panel P by the user D (step S103).

Then, the vibration control unit 12f controls the vibration element 13a of the vibration unit 13 in accordance with the set vibration condition information 80b.

When the operation in the process is enabled (step S104, Yes), in other words, when the selection of the to-be-controlled object by the selection unit 12c is enabled, the vibration control unit 12f gives a tactile sensation appropriate to the to-be-controlled object as feedback by vibrating the vibration element 13a in accordance with the vibration condition information 80b (step S105). Then, the process ends.

Note that the user D needs to select the vibration pattern appropriate to the gesture that the user D desires in order to give the vibration pattern appropriate to each gesture to the user in step S105. For example, the vibration can be selected in accordance with the voice recognition through the microphone 20.

When the voice recognition is used, the following process is performed. For example, when the user D wants to make the gesture “circle”, the user says, for example, “Circle.”. Then, the voice receiver 12a receives and analyses the voice, and gives the analysis result to the selection unit 12c.

The selection unit 12c selects the gesture “circle” in accordance with the analysis result, and notifies the setting unit 12d that the gesture “circle” is selected. The setting unit 12d receives the notification, and selects the vibration pattern appropriate to the gesture “circle” from the patterns for the selected to-be-controlled object in the combination information 80a. Then, the setting unit 12d sets the information indicating that the selected vibration pattern is “currently set” into the vibration condition information 80b.

Then, in accordance with the setting result, the vibration control unit 12f controls the vibration element 13a of the vibration unit 13 to generate the vibration pattern appropriate to the gesture “circle” desired by the user D. After that, the user D only needs to make the gesture “circle” by moving the finger U1, for example, while being guided along the region R1 illustrated in FIG. 3A.

As illustrated in FIG. 6, when the operation is disabled (step: S104, No), in other words, when the selection of the to-be-controlled object by the selection unit 12c is disabled, the vibration control unit 12f does not vibrate the vibration element 13a in accordance with the vibration condition information 80b and thus does not give a tactile sensation appropriate to the to-be-controlled object as feedback (step S105). Then, the process ends.

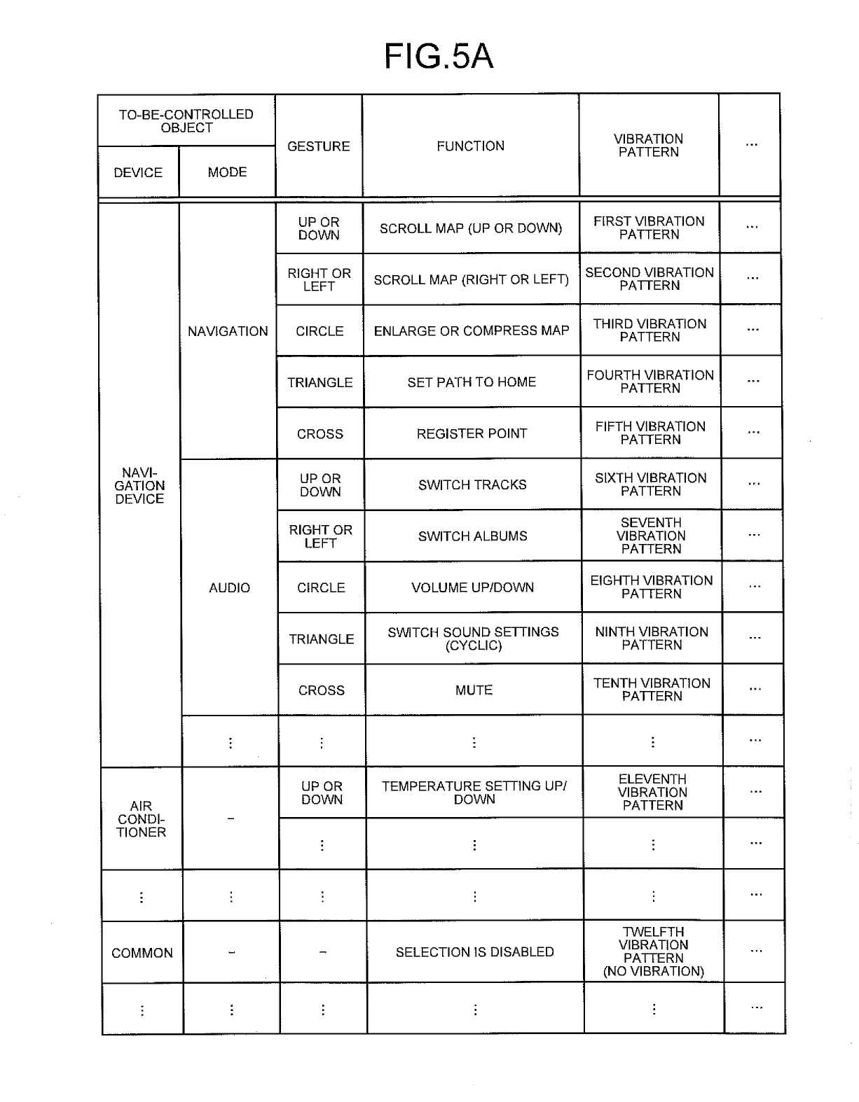

The integrated input system 1 according to the present embodiment can be implemented with a computer 600 having a configuration illustrated as an example in FIG. 7. FIG. 7 is a diagram of the hardware configuration of an exemplary computer that implements the functions of the integrated input system 1 according to an embodiment.

The computer 600 includes a Central Processing Unit (CPU) 610, a Read Only Memory (ROM) 620, a Random Access Memory (RAM) 630, and a Hard Disk Drive (HDD) 640. The computer 600 further includes a medium interface (I/F) 650, a communication interface (I/F) 660, and an input and output interface (I/F) 670.

Note that the computer 600 can include a Solid State Drive (SSD) so that the SSD performs some or all of the functions of the HDD 640. Alternatively, the SSD can be provided instead of the HDD 640.

The CPU 610 operates in accordance with a program stored in at least one of the ROM 20 and the HDD 640 so as to control each unit. The ROM 620 stores a boot program executed by the CPU 610 when the computer 600 starts or a program depending on the hardware of the computer 600. The HDD 640 stores the programs executed by the CPU 610 and the data used by the programs.

The medium I/F 650 reads the program and data stored in a storage medium 680, and provides the program and data through the RAM 630 to the CPU 610. The CPU 610 loads the provided program through the medium I/F 650 from the storage medium 680 onto the RAM 630 so as to execute the program. Alternatively, the CPU 610 executes the program using the provided data. The storage medium 680 is, for example, a magneto-optical recording medium such as a Digital Versatile Disc (DVD), an 3D card, or a USB memory.

The communication I/F 660 receives the data from another device through a network 690 and transmits the data to the CPU 610, The communication I/F 660 transmits the data generated by the CPU 610 through the network 690 to another device. Alternatively, the communication I/F 660 receives a program through the network 690 from another device, and transmits the program to the CPU 610 so that the CPU 610 executes the transmitted program.

The CPU 610 controls, through the input and output I/F 670, the display unit 40 such as a display, the output unit such as the loudspeaker 70, and the input unit such as a keyboard, a mouse, a button, or the operation unit 11. The CPU SID obtains the data through the input and output I/F 670 from the input unit. The CPU 610 outputs the generated data through the input and output I/F 670 to the display unit 40 or the output unit.

For example, when the computer 600 functions as the integrated input system 1, the CPU 610 of the computer 600 implements each of the functions of the control unit 12 of the input device 10 including the voice receiver 12a, the sight line detector 12b, the selection unit 12c, the setting unit 12d, the detector 12e, the vibration control unit 12f, and the operation processor 12g, and the function of the display control unit 50 by executing the program loaded on the RAM 630.

The CPU 610 of the computer 600 reads the programs, for example, from the storage medium 680 to execute them. As another example, the CPU 610 can obtain the program from another device through the network 690. The HDD 640 can store the information stored in the storage unit 80.

As described above, the input device according to an embodiment includes an operation panel, a selection unit, a detector, at least a vibration element, a setting unit, and a vibration control unit. The selection unit selects a to-be-controlled object on the operation panel in accordance with the user's action.

The detector detects a predetermined type of touch operation on the operation panel by the user. The vibration element vibrates the operation panel. When the detector detects touch operation, the setting unit sets a vibration pattern of the vibration element appropriate to the touch operation depending on the to-be-controlled object selected by the selection unit.

When the detector detects touch operation, the vibration control unit controls the vibration element to generate the vibration pattern set by the setting unit.

Thus, the input device according to an embodiment enables the user to operate various to-be-controlled objects with a high degree of usability.

Note that, although an example in which the selection unit 12c selects a to-be-controlled object in accordance with the voice input from the microphone 20 or the detection of line of sight of the user D has been described in the embodiment, the selection is not limited to the example. For example, the input device 10 can include a switch for switching to-be-controlled objects so that a to-be-controlled object can be selected by the user D's action that the user D merely presses the switch to switch the objects.

An example in which there is only an operation panel P has been described in the embodiment. However, the operation panel P can be divided into a plurality of sections so that the vibration control unit 12f controls the vibration element 13a to give different tactile sensations as feedback on the different sections, respectively.

In such a case, for example, each mode of the navigation device can be allotted to each section so that the user D selects each region in accordance with the given tactile sensation as feedback. This selection enables the selection unit 12c to select the mode as the to-be-controlled object on the operation panel P. This enables the user D to easily perform the operation for selecting a made as a to-be-controlled object without voice recognition or sight line detection.

Specifically, the operation panel P has a plurality divided sections, and different modes are allotted to the divided sections, respectively. Then, the vibration control unit 12f controls the vibration element 13a to generate different vibration patterns in the divided sections, respectively. The selection unit 12c selects the mode corresponding to the divided section that the user D selects in accordance with the tactile sensation given from each the divided sections as feedback.

By the way, when the input device 10 receives a voice input through the voice receiver 12a while the vibration unit 13 is vibrating, the vibration of the input device 10 propagates to the air and sometimes interferes with the voice input.

In light of the foregoing, an input device 10 according to an exemplary variation includes an exclusion control unit that exclusively controls the reception of a voice input by the voice receiver 12a and the reception of input operation by the detector 12e. The exclusion control unit stops the detector 12e from detecting touch operation and stops the vibration unit 13 from vibrating while allowing the voice receiver 12a to receive a voice input. This prevents the vibration unit 13 from vibrating while the voice receiver 12a receives a voice input, and thus can reduce the interference with the voice input.

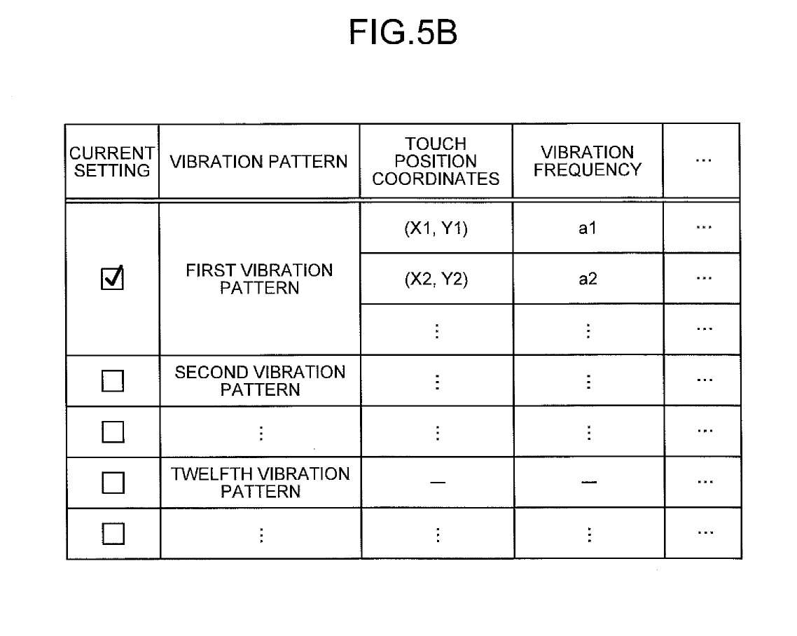

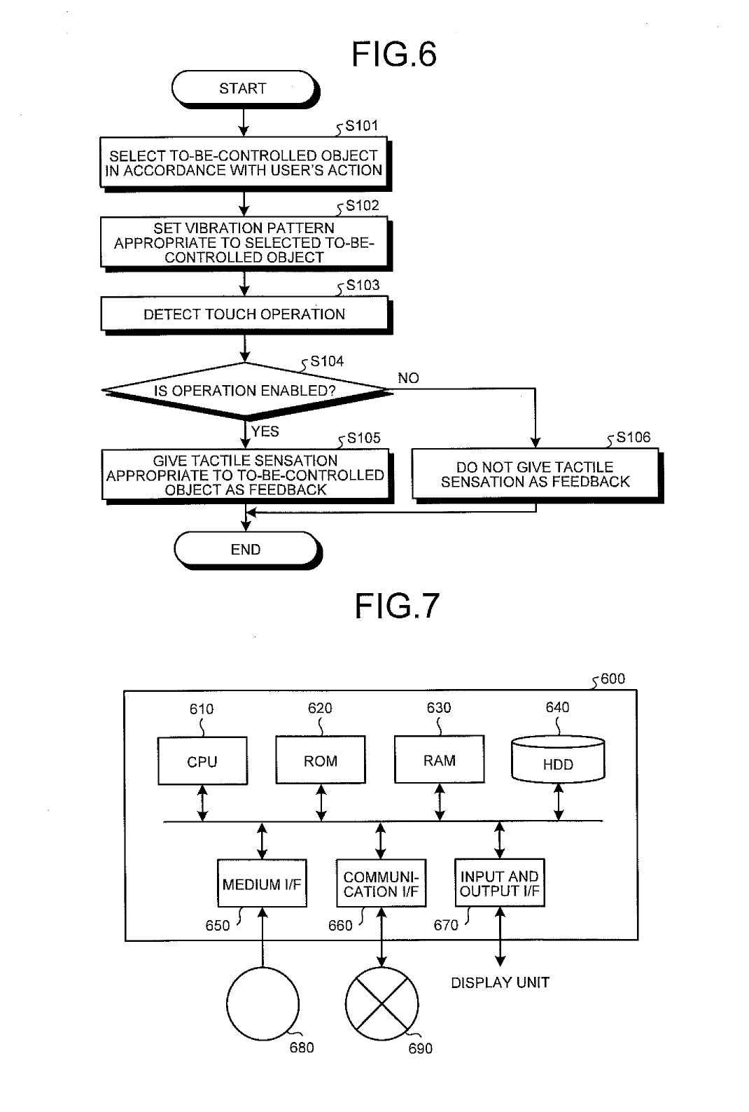

An input device control method for controlling the input device 10 according to the exemplary variation will be described hereinafter with reference to FIGS. 8 to 11. FIG. 8 is a timing diagram of an exemplary input device control method for controlling the input device 10 according to an exemplary variation. FIG. 9 is an exemplary displayed screen.

In this example, a case in which the user sets TOKYO SKYTREE as the destination onto the navigation device using the input device 10 will be described. In the example to be described below, a state in which the exclusion control unit allows the detector 12e or the voice receiver 12a to receive input is referred to as “ON state” and a state in which the exclusion control unit stops the detector 12e or the voice receiver 12a from receiving input is referred to as “OFF state”.

As illustrated in FIG. 8, for example, the user performs neither touch operation, nor a voice input on the input device 10 (Receiving Input Operation: OFF, and Receiving Voice Input: OFF), and the detector 12e is in the ON state while the voice receiver 12a is the OFF state (between times t0 and t1). In this example, when the user writes, for example, “G” on the operation panel P with the finger at the time t1, the vibration control unit 12f vibrates the operation panel P with the vibration pattern appropriate to the input operation (between times t1 and t2).

The detector 12e determines the input operation as a request for shifting the navigation mode to a destination setting mode, and outputs the determination result to the exclusion control unit and the navigation device.

When obtaining the determination result, the exclusion control unit, for example, shifts the detector 12e to the OFF state and the voice receiver 12a to the ON state after awaiting that a predetermine period of time (the time t2 to t3) has elapsed (a time t3). When obtaining the determination result from the input device 10, the navigation device shifts the navigation mode to the destination setting mode.

During the period between the times t2 and t3, the input device 10 outputs a voice guidance, for example, saying “Where would you like to set your destination?” from the loudspeaker 70. In this example, during the voice guidance, the voice receiver 12a is in the OFF state. This can prevent incorrect input caused by the voice guidance.

When the exclusion control unit switches the detector 12e and the voice receiver 12a to the ON or OFF state, the input device 10 notifies the user of the switched state. Methods for the notification include outputs such as a specific vibration pattern of the operation panel P, a voice from the loudspeaker 70, and a navigation screen displayed on the display unit 40.

Alternatively, for example, an illuminant can be provided at a position at which the user can visually recognize the illuminant (for example, on the steering wheel). The states of the detector 12e and the voice receiver 12a can be notified, for example, by the color of the illuminant. This enables the user to easily grasp the ON/OFF states of the detector 12e and the voice receiver 12a.

In response to the voice guidance, the user says “TOKYO SKYTREE.” as if the user has a conversation with the voice guidance during the period between times t4 and t5. This use's speech causes the voice receiver 12a to output the voice data to the navigation device.

This output causes the navigation device to start searching for a candidate site corresponding to TOKYO SKYTREE on the map information stored in the navigation device, and outputs the search result to the display unit 40 (see FIG. 9).

When the voice receiver 12a completes receiving the voice input, the exclusion control unit shifts the voice receiver 12a to the OFF state, and the detector 12e to the On state (at and after a time t6).

In the example illustrated in FIG. 9, there are 20 candidate sites for TOKYO SKYTREE, and a list indicating some of the candidate sites is displayed on the display unit 40. For example, a cursor C and an operation button B are also displayed on the display unit 40. The user selects the destination from the candidate sites by the position of the cursor C, and operates the cursor C by the touch operation on the operation panel F. In this example, the operation button B can cooperate with a vibration pattern of the operation panel F.

In other words, when the user moves the finger up or down while keeping the finger in contact with the operation panel P, the user can obtain the tactile sensation for operating the operation button B. Specifically, with the user's touch operation for moving the position of the cursor C to the next position, the vibration control unit 12f controls the ON/OFF of the vibration unit 13 to give the user a tactile sensation as if the user actually operates the button B (t7 to t8).

When the cursor C reaches the desired candidate site, the user determines the destination by performing predetermined operation (for example, tap operation). Then, the detector 12e outputs the user's input operation to the navigation device. In this example, the input device 10 outputs a voice guidance, for example, saying “Is this place your destination?” from the loudspeaker 70.

When the user continuously performs predetermined operation (for example, tap operation), the input device 10 determines the destination and outputs a signal indicating the determination to the navigation device. This completes the destination setting of the navigation device.

As described above, the exclusion control unit can exclusively control the ON/OFF states of the detector 12e and the voice receiver 12a in response to the user's input operation. This exclusive control enables the user to separately use the touch operation and the voice input. Thus, the user can easily perform desired input operation. Meanwhile, the input device 10 can narrow the range of purposes of the user's next speech by previously shifting the mode by the input operation. This narrowing can improve the accuracy of the voice input performed by the voice receiver 12a.

Note that, when the user performs touch operation without a voice input while the voice receiver 12a is in the ON state (for example, between the times t3 and t6), the exclusion control unit can shift the voice receiver 12a to the OFF state and the detector 12e to the ON state so that the detector 12e can receive the touch operation.

Alternatively, when the user does not perform a voice input for a predetermined period of time while the voice receiver 12a is in the ON state (for example, between the times t3 and t6), the exclusion control unit can shift the voice receiver 12a to the OFF stats and the detector 12e to the ON state.

When the user performs predetermined operation (for example, double-tap operation) while the detector 12e is the ON state (for example, at and after the time t6), the exclusion control unit can set the voice receiver 12a into the ON state and shift the detector 12e to the OFF state. This enables the user to set a destination by saying voice, for example, “the second” or “the TOKYO SKYTREE first car park” corresponding to the displayed screen while looking at the displayed candidate list.

In this example, a case in which the exclusion control unit alternately switches the ON/OFF states of the detector 12e and the voice receiver 12a has been described. The switching is not limited to the example. For example, the exclusion control unit sets both the detector 12e and the voice receiver 12a into the ON state, and controls only the voice receiver 12a to shift to the OFF state when the detector 12e receives touch operation.

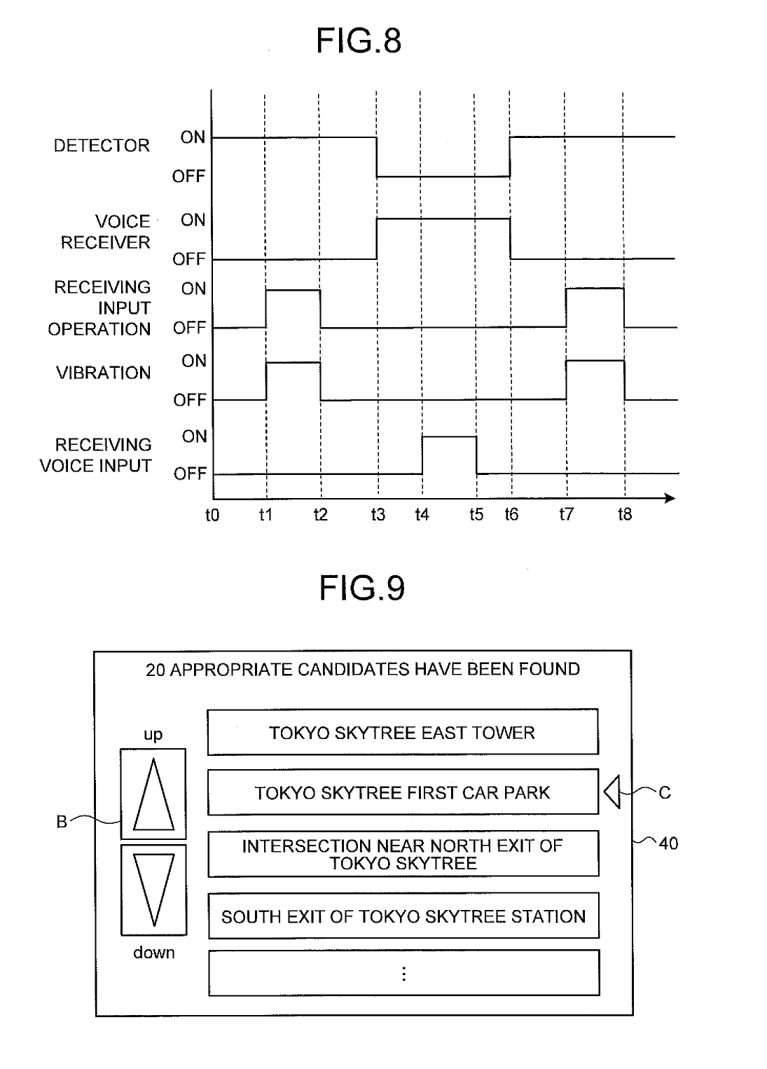

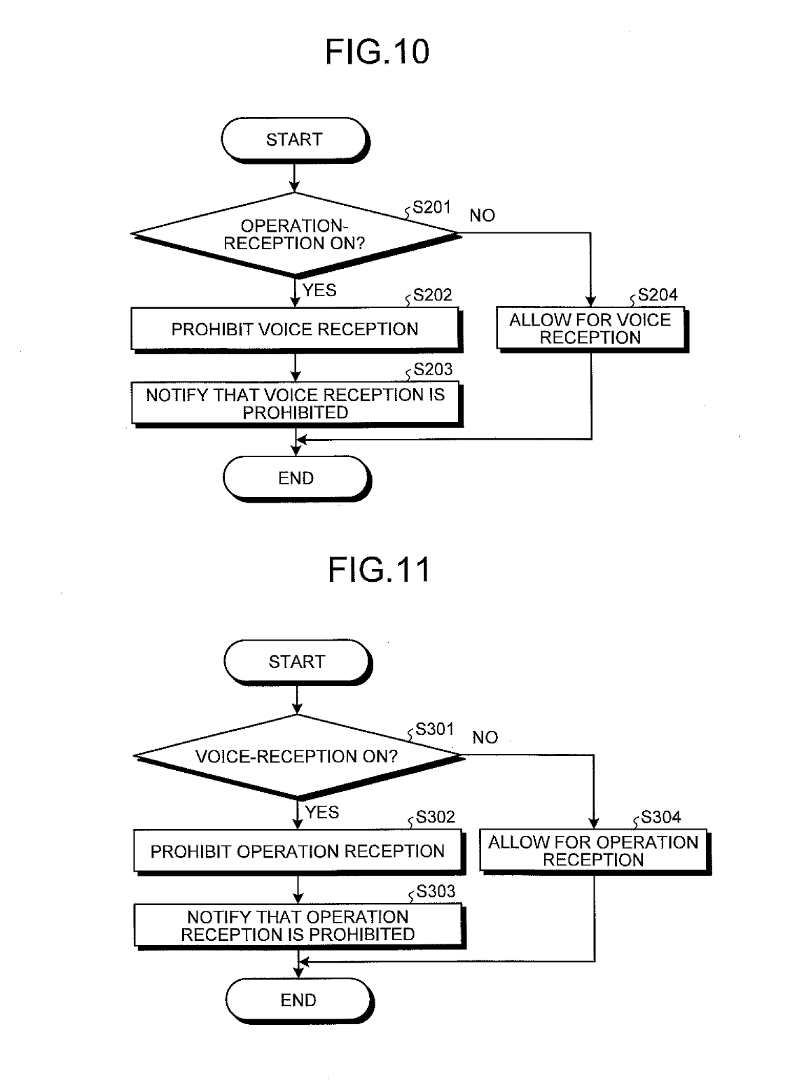

Next, excluding processes that the input device 10 according to the exemplary variation performs will be described with reference to FIGS. 10 and 11. FIG. 10 is a flowchart of an exemplary first excluding process that the input device 10 according to the exemplary variation performs. FIG. 11 is a flowchart of an exemplary second excluding process that the input device 10 according to the exemplary variation performs.

Note that these examples will be described on the assumption that the excluding process performed when touch operation is performed on the input device 10 is the first excluding process, and the excluding process performed when a voice input is performed is the second excluding process.

As illustrated in FIG. 10, in the first excluding process, when the detector 12e detects a touch on the operation panel P, the exclusion control unit of the input device 10 determines whether the detector 12e is in an operation-reception ON state in which the detector 12e can receive operation (step S201). When the detector 12e is in the operation-reception ON state (step S201, Yes), the exclusion control unit prohibits the voice receiver 12a from receiving voice (step S202).

Next, the exclusion control unit notifies the user of the prohibition on voice reception through the display unit 40 or the loudspeaker 70 (step S203). Then, the process ends. On the other hand, when the detector 12e is in an operation-reception OFF state in which the detector 12e does not receive operation in the determination of step S201 (step S201, No), the exclusion control unit allows the voice receiver 12a to receive voice (step S204). The process ends.

The second excluding process that the input device 10 performs will be described with reference to FIG. 11. As illustrated in FIG. 11, when a voice is input to the microphone 20, the exclusion control unit of the input device 10 determines whether the voice receiver 12a is in a voice-reception ON state in which the voice receiver 12a can receive voice (step S301). When the voice receiver 12a is in the voice-reception ON state (step S301, Yes) the exclusion control unit prohibits the detector 12e from receiving operation (step S302).

Next, the exclusion control unit notifies the user of the prohibition on operation-reception through the display unit 40 or the loudspeaker 70 (step S303). Then, the process ends. On the other hand, when the voice receiver 12a is in a voice-reception OFF state in which the voice receiver 12a does not receive voice in the determination of step S301 (step S301, No), the exclusion control unit allows the detector 12e to receive operation (step S304). The process ends.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An input device comprising:
an operation panel;
a selection unit that selects a to-be-controlled object using the operation panel in accordance with a user's action;
a detector that detects predetermined touch operation, that being performed on the operation panel by the user;
at least a vibration element that vibrates the operation panel;
a setting unit that sets a vibration pattern of the vibration element appropriate to the touch operation depending on the to-be-controlled object selected by the selection unit when the detector detects the touch operation; and
a vibration control unit that controls the vibration element to generate the vibration pattern set by the setting unit when the detector detects the touch operation.

2. The input device according to claim 1,
wherein the touch operation includes a plurality of easy gestures including a touch on the operation panel,
the setting unit sets the vibration pattern to be generated when each of the gestures is performed to operate the to-be-controlled object selected by the selection unit in accordance with combination information in which different vibration patterns are combined with the gestures, respectively, depending on the to-be-controlled objects.

3. The input device according to claim 1,
wherein the to-be-controlled object is one of a plurality of devices.

4. The input device according to claim 1,
wherein the to-be-controlled object is one of modes included in a device.

5. The input device according to claim 1, further comprising:
a voice receiver that receives a voice input,
wherein the selection unit selects the to-be-controlled object in accordance with contents of the voice input received by the voice receiver.

6. The input device according to claim 1, further comprising:
a sight line detector that detects a direction of line of sight of the user in accordance with a taken image from an image pickup unit that takes an image of the user,
wherein the selection unit selects the to-be-controlled object in accordance with a detection result detected by the sight line detector.

7. The input device according to claim 5, further comprising:
a sight line detector that detects a direction of line of sight of the user in accordance with a taken image from an image pickup unit that takes an image of the user,
wherein the selection unit selects the to-be-controlled object in accordance with a detection result detected by the sight line detector.

8. The input device according to claim 1,
wherein, when selection of the to-be-controlled object by the selection unit is enabled and the detector detects the touch operation to operate the to-be-controlled object,
the vibration control unit controls the vibration element to generate a vibration pattern that gives the user a tactile sensation as feedback through the operation panel.

9. The input device according to claim 1,
wherein, when selection of the to-be-controlled object by the selection unit is disabled and the detector detects the touch operation to operate the to-be-controlled object,
the vibration control unit controls the vibration element to generate a vibration pattern that does not give the user a tactile sensation as feedback through the operation panel.

10. The input device according to claim 1,
wherein the operation panel includes a plurality of divided sections and the divided sections are allotted different to-be-controlled objects, respectively,
the vibration control unit controls the vibration element to generate different vibration patterns on the divided sections, respectively, and
the selection unit selects the to-be-controlled object corresponding to the divided section selected by the user in accordance with the tactile sensation given as feedback from each of the divided sections.

11. The input device according to claim 1,
wherein, when a tactile sensation is given as feedback to the user through the operation panel, a guidance voice output by a voice output unit is used together with the tactile sensation.

12. An integrated input system comprising:
the input device according to claim 1; and
a display unit that displays an image in response to predetermined touch operation, the predetermined touch operation being performed on the operation panel by the user.

13. An input device control method for controlling an input device including an operation panel, the method comprising:
detecting predetermined touch operation, the predetermined touch operation being performed on the operation panel by a user;
selecting a to-be-controlled object using the operation panel in accordance with a user's action;
vibrating the operation panel using at least a vibration element;
setting a vibration pattern of the vibration element appropriate to the touch operation depending on the selected to-be-controlled object when the touch operation is detected; and
controlling the vibration element to generate the set vibration pattern when the touch operation is detected.

14. A non-transitory computer-readable medium storing instructions executable by a computer, wherein the instructions cause the computer to perform:
detecting predetermined touch operation, the predetermined touch operation being performed on an operation panel by a user;
selecting a to-be-controlled object using the operation panel in accordance with a user's action;
vibrating the operation panel using at least a vibration element;
setting a vibration pattern of the vibration element appropriate to the touch operation depending on the selected to-be-controlled object when the touch operation is detected; and
controlling the vibration element to generate the set vibration pattern when the touch operation is detected.
